(19) United States
(12) Patent Application Publication
(10) Pub. No.: US 2025/0072661 A1
(43) Pub. Date: Mar. 6, 2025

(54) ACCESSORY MOUNT AND ACCESSORIES FOR SMOKER OR OUTDOOR GRILL

(71) Applicant: GMG Products, LLC, Lakeside, OR (US)

(72) Inventor: Brett Maister, Santa Ana, CA (US)

(21) Appl. No.: 18/241,085

(22) Filed: Aug. 31, 2023

(51) Int. Cl. A47J 37/07

(52) U.S. Cl. CPC A47J 37/0786

(57) ABSTRACT

A cooker, such as a smoker or grill, has an accessory mount secured thereto, such as to a backwall. The accessory mount includes a mounting plate with accessory mount openings that is secured to the cooker by mounting flanges offset from the mounting plate. Accessory mount flanges mount are positioned between the mounting flanges and the mounting plate and include accessory mounting features aligned with the accessory mount openings. An accessory includes rods inserted through the accessory mount openings and engaged with the accessory mounting features. The rods may have a widened end positioned between the accessory mount flanges and mounting flanges.

### FIELD OF THE INVENTION

This application relates to an accessory mount for a smoker or outdoor grill and accessories for mounting thereto.

### BACKGROUND OF THE INVENTION

Smokers and outdoor grills are popular cooking tools for preparing meats and other foods. Smokers often include a pellet feeding system in order to provide improved temperature control whereas an outdoor grill will include a gas burner or electric heating element. Although quite capable for roasting and grilling meat, it would be advantageous to extend the capability of a smoker or outdoor grill to perform other cooking functions.

### SUMMARY OF THE INVENTION

In one aspect of the invention, an apparatus includes a mounting panel having a front surface defining accessory mount openings. A mounting flange is offset from the mounting panel in a first direction perpendicular to the front surface. The mounting flange is configured to mount the mounting panel to a wall of a cooker. An accessory mount flange is positioned between the mounting panel and the mounting flange along the first direction and offset from the mounting panel along the first direction, the accessory mount flange defining a plurality of accessory mounting features, each accessory mounting feature of the plurality of accessory mounting features being aligned with one accessory mount opening of the accessory mount openings along a second direction perpendicular to the first direction.

Each accessory mounting feature of the plurality of accessory mounting features may be one of an opening and an open-ended indentation. In some embodiments, the accessory mount flange is a first accessory mount flange and the plurality of accessory mounting features are first accessory mounting features. The apparatus further includes a second accessory mount flange positioned between the mounting flange and the mounting panel along the first direction, the first and second accessory mount flanges offset from one another in the second direction. The second accessory mount flange defines second accessory mounting features. The first accessory mounting features may be open-ended indentations and the second accessory mounting features may each be an opening with a closed perimeter. In some embodiments, each mounting features includes first and second surfaces angled inwardly toward one another.

In some embodiments, the mounting flange is a first mounting flange and the apparatus further includes a second mounting flange offset from the first mounting flange in the second direction. A first extension extends between the mounting panel and the first mounting flange. A second extension extends between the mounting panel and the second mounting flange.

In some embodiments, the accessory mount flange is a first accessory mount flange and the plurality of accessory mounting features are first accessory mounting features. The apparatus may further include a second accessory mount flange defining second accessory mounting features. The first accessory mount flange may be secured to the first extension and extend outwardly from the first extension and toward from the second extension. The second accessory mount flange may be secured to the second extension and extend outwardly from the second extension and toward the first extension. In some embodiments, the first mounting flange is secured to the first extension and extends outwardly from the first extension and toward from the second extension and the second mounting flange is secured to the second extension and extends outwardly from the second extension and away from the first extension.

In another aspect of the invention, a system includes a cooker including a housing defining a cooking chamber, a heat source, and a plurality of mounting points accessible within the cooking chamber. The system includes an accessory mount comprising a mounting panel defining accessory mount openings. The accessory mount includes first and second mounting flanges offset from the mounting panel in a first direction and secured to the plurality of mounting points. An accessory munt flange is positioned between the mounting panel and the first and second mounting flanges along the first direction, the accessory mount flange defining a plurality of accessory mounting features, each accessory mounting feature of the plurality of accessory mounting features being aligned with one accessory mount opening of the accessory mount openings along a second direction perpendicular to the first direction. The system further includes an accessory including a first rod extending into a first accessory mount opening of the accessory mount openings and engaging a first accessory mounting feature of the plurality of accessory mounting features that is aligned with the first accessory mount opening along the second direction; and a second rod extending into a second accessory mount opening of the accessory mount openings and engaging a second accessory mounting feature of the plurality of accessory mounting features aligned with the second accessory mount opening along the second direction.

In some embodiments, the first rod has a first widened end portion positioned between the first mounting flange and the accessory mount flange along the first direction and the second rod has a second widened end portion positioned between the first mounting flange and the accessory mount flange along the first direction.

The accessory may include a grill mounted to the first and second rods. The accessory may include a rack including one or more dividers. The accessory may include a tray supported by the first and second rods. The accessory may include a grill supported by the tray.

A grill may be positioned within the housing between the plurality of mounting points and the heat source. The heat source may be at least one of a burn box and pellet feeder, a gas burner, a chip feeder, and an electric heating element.

In some embodiments, each accessory mounting feature of the plurality of accessory mounting features may be one of an opening and an open-ended indentation.

In some embodiments, each mounting feature includes first and second surfaces angled inwardly toward one another, the first rod seated against the first and second surfaces of the first accessory mounting feature and the second rod pressing upwardly against the first and second surfaces of the second accessory mounting feature.

In some embodiments, the accessory mount flange is a first accessory mount flange and the plurality of accessory mounting features are first accessory mounting openings. The accessory mount may further include a second accessory mount flange positioned between the mounting panel and the first and second mounting flanges along the first direction, the second accessory mount flange defining second accessory mounting features. The first accessory mounting features may be open-ended indentations and the second accessory mounting features may each be an opening with a closed perimeter.

In some embodiments, a first extension extends between the mounting panel and the first mounting flange and a second extension extends between the mounting panel and the second mounting flange. The first accessory mount flange may be secured to the first extension and extend outwardly from the first extension and toward from the second extension. The second accessory mount flange may be secured to the second extension and extend outwardly from the second extension and toward the first extension.

### BRIEF DESCRIPTION OF THE DRAWINGS

Preferred and alternative examples of the present invention are described in detail below with reference to the following drawings:

FIG. 1 is an isometric grill of a smoker in accordance with an embodiment of the present invention;

FIG. 2 is an isometric view of clip for securing to a wall of the smoker to provide a mounting point for an accessory mount in accordance with an embodiment of the present invention;

FIG. 3 is a front isometric view of an accessory mount in accordance with an embodiment of the present invention;

FIG. 4 is a rear isometric view of the accessory mount of FIG. 3;

FIG. 5 illustrates accessory mount openings and indentations in accordance with an embodiment of the present invention;

FIG. 6 is a rear isometric view showing the mounting of an accessory to the accessory mount in accordance with an embodiment of the present invention;

FIG. 7 is a front isometric view showing mounting of an accessory to the accessory mount in accordance with an embodiment of the present invention; and

FIG. 8 is a front isometric view showing mounting of an accessory to the accessory mount in accordance with an embodiment of the present invention.

### DETAILED DESCRIPTION OF THE PREFERRED EMBODIMENT

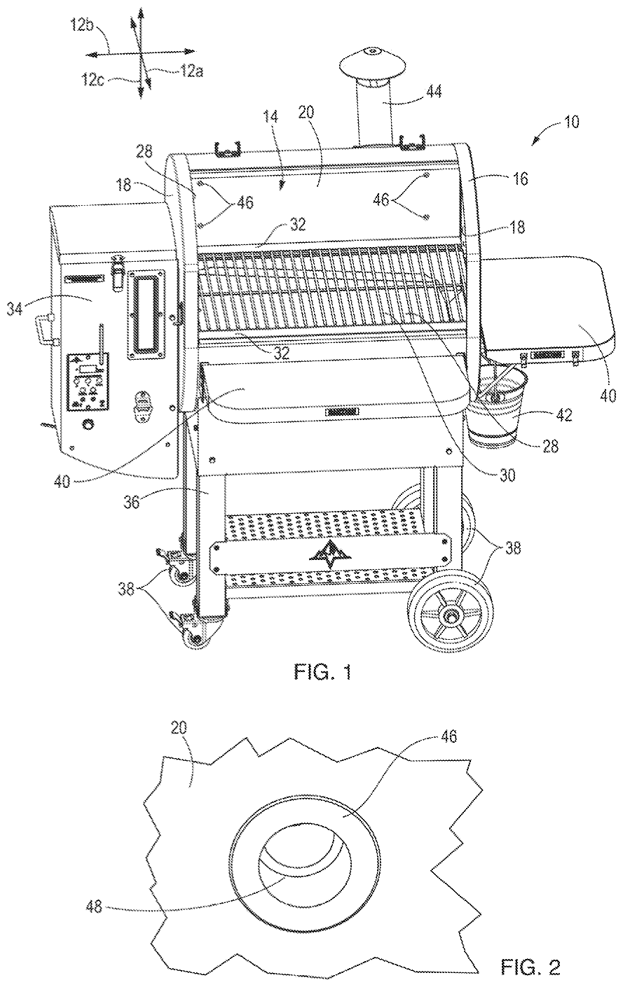

Referring to FIG. 1, a cooker 10 may be implemented as the illustrated smoker or an outdoor grill, portable pizza oven, or any other type of cooking apparatus. The cooker 10 and accessory mount therefor as described below may be understood with respect to a longitudinal 12a, a horizontal direction 12b, and a vertical direction 12c that are all perpendicular to one another. The directions 12a, 12b, 12c are used herein to describe the relative position and orientation of parts but need not correspond to actual orientation during use. For example, the vertical direction 12b may be substantially (e.g., within 5 degrees of) parallel to the direction of gravity during use, however, other orientations are possible.

The cooker 10 includes a cooking chamber 14 embodied as a three-dimensional space that is at least partially enclosed by walls of the cooker 10. For example, the cooking chamber may be defined by a housing 16 including sidewalls 18 offset from one another in the horizontal direction 12b. The sidewalls 18, or at least a major portion thereof, may be planar and parallel to the longitudinal direction 12a and the vertical direction 12c.

The housing 16 includes a backwall 20 secured to and extending between the sidewalls 18. The backwall 20, or at least major portion thereof, may be planar and substantially (e.g., within 5 degrees of) parallel to the horizontal direction 12b and vertical direction 12c.

The housing 16 may include a front wall 22 offset from the backwall 20 along the longitudinal direction 12a. The front wall 22 may be planar and substantially (e.g., within 5 degrees of) parallel to the horizontal direction 12b and vertical direction 12c.

A top wall 24 may extend outwardly from the top edge of the back wall 20. A bottom wall 26 may extend outwardly from the bottom edge of the back wall 20 and be offset from the top wall 24 along the vertical direction 12c. The top wall 24 and bottom wall 26, or at least a major portion thereof, may be planar and substantially (e.g., within 5 degrees of) parallel to the longitudinal direction 12a and horizontal direction 12b.

An area between the sidewalls 18 and the top and bottom walls 24, 26 may define an opening 28 through which items are inserted into and removed from the cooking chamber. The opening 28 may be coverable by a lid (not shown) attached by a hinge to the top wall 24.

In some embodiments, the housing 16 includes side walls 18 and the backwall 20, front wall, 22, top wall 24, and bottom wall 26 are substantially cylindrical in shape about a cylinder with an axis of symmetry parallel to the horizontal direction 12b. The backwall 20, front wall, 22, top wall 24, and bottom wall 26 may therefore be parts of a single piece of metal, such as steel, rolled to conform to the cylinder. As used herein “substantially cylindrical” may be understood as being such that a cylindrical shape of radius R may be defined such that all points on the backwall 20, front wall, 22, top wall 24, and bottom wall 26 are within 0.05 R from the cylindrical shape. A portion of the backwall 20 may be planar or have a planar member secured thereto to facilitate mounting of an accessory mount as described herein.

The cooker 10 may include a grill 30 positioned within the cooking chamber 14 and extending substantially (e.g., at least 90 percent) between the sidewalls 18 and between the back wall 20 and the front wall 22. The grill 30 may rest on flanges 32 secured to the sidewalls 18 and/or the back wall 20 and front wall 22.

The cooker 10 may include a heating structure, such as a burn box, gas heating element, or electric heating element (not shown) within the housing 16 below the grill 30. The cooker 10 embodied as a smoker may include an external pellet feeder 34, which may be thermostatically controlled. The housing 16 may be mounted on a support frame 36, which may itself be supported by wheels 38 or other ground engaging member. Other accessories may secure to the housing 16, such as one or more shelves 40, an ash collection basket 42, a chimney 44, or the like.

The illustrated cooker 10 is exemplary only. The accessory mount described herein may be used with a conventional oven in a home or recreational vehicle. The accessory mount disclosed herein may also provide a convenient approach for mounting items to other structures in other contexts that do not involve cooking.

Referring to FIG. 2, while still referring to FIG. 1, the accessory mount disclosed herein may mount to the back wall 20, sidewall 18, or other portion of the housing 16. In the illustrated embodiment, the back wall 20 has threaded studs 46 mounted thereto. The threaded studs 46 define an internally threaded opening 48 for receiving a threaded fastener. The threaded studs 46 may be implemented as nutserts, threaded clips, an internally and externally threaded bolt secured to the back wall 20, or other structure. The back wall 20 may be made of a thin metal such that the threaded studs 46 are used. However, in other embodiments, the back wall 20, or a reinforcing panel secured thereto, may have sufficient thickness to enable a threaded hole to be formed directly in the back wall 20. In the illustrated embodiments, there are four threaded studs 46 arranged at corners of a rectangular shape. However, more, fewer, and other arrangements of the studs 46 may be used. In some embodiments, other mounting approach other than threaded holes may be used, such as hooks, slots, any type of clip, or any other mounting approach known in the art. The threaded studs 46 may be distributed in a plane parallel to the horizontal direction 12b and the vertical direction 12c. A threaded opening of each threaded stud 46 may receive a fastener inserted and threaded into the threaded stud 46 along the longitudinal direction 12a, e.g., rotation of the threaded fastener into the threaded stud 46 when threading into the threaded stud 46 being about an axis of rotation substantially (e.g., within 5 degrees of) parallel to the longitudinal direction 12a.

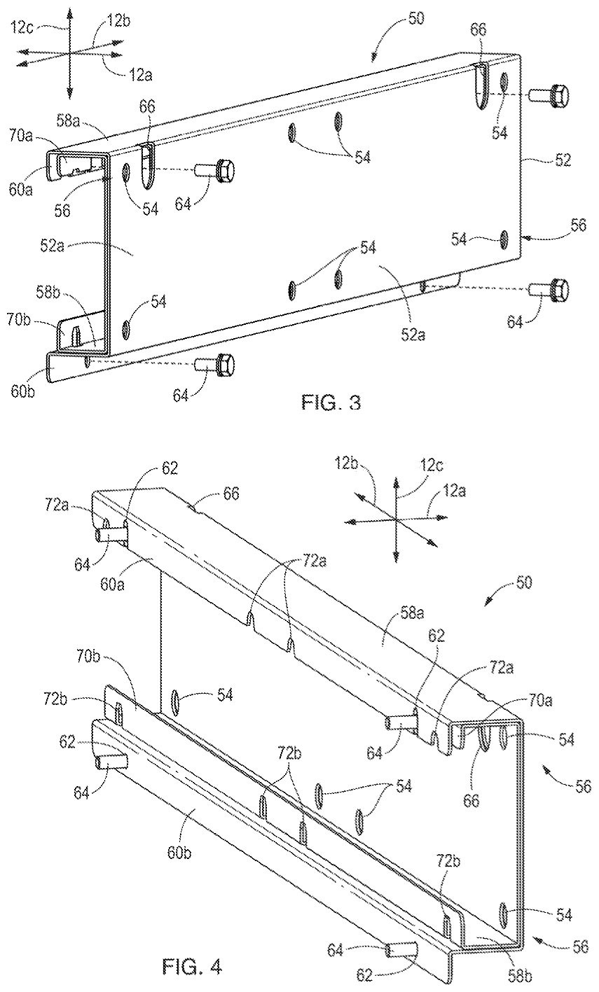

FIGS. 3 and 4 illustrate an accessory mount 50 that may be mounted to the cooker, such as using the threaded openings 48 provided by the threaded studs 46 or other structure or according to some other fastening approach.

The accessory mount 50 includes a mounting panel 52. The mounting panel 52 may be planar, e.g., a flat plate. For example, the mounting panel 52 may include an outward facing surface 52a that is substantially (e.g., within 5 degrees of) parallel to the horizontal and vertical directions 12b, 12c when secured to the back wall 20. If secured to the backwall, the outward facing surface 52a may be parallel to the longitudinal and vertical directions 12a, 12c.

The mounting panel 52 defines a plurality of accessory mount openings 54. The accessory mount openings 54 may be arranged in groups 56 of two, three, four or more having centers thereof lying on a straight line, such as a straight line substantially (e.g., within 5 degrees of) parallel to the horizontal direction 12b when the accessory mount 50 is mounted to the back wall 20 and to the longitudinal direction 12a when the accessory mount 50 is mounted to a sidewall 18. In the illustrated embodiment, the accessory mount openings 54 may be in two groups 56 offset from one another along the vertical direction 12c during use. Each group 56 may include two outer openings 54 and two inner openings 54, the two inner openings 54 being located between the two outer openings 54 and being much closer to one another than to the closest outer opening 54. For example, the distance between the two inner openings 54 may be less than half of a distance between each inner opening 56b and a closest of the outer openings 54. The outer openings 54 of each group may be offset from one another by a distance within 75, 80, 90 or 95 percent of the width of the mounting panel 52 in the horizontal direction 12b during use. In use, any two openings 52 of each group 56 may be used simultaneously to support a single item, for example, the two outer openings 54, an outer opening 54 and a closest inner opening 54, or other combination. In other methods of use, a single opening 54 or any three or more openings 54 may be used simultaneously to support a single item. In the illustrated embodiment, the accessory mount openings 54 are circular, though other shapes, such as square, hexagonal, or octagonal may also be used.

The accessory mount 50 includes one or more extensions 58a, 58b secured to the mounting panel 52 and extending away from the outward facing surface 52a of the mounting panel 52 in at least the longitudinal direction 12a (when mounted to the back wall 22) or the horizontal direction (when mounted to a side wall 18). In the illustrated embodiment, there are two extensions 58a, 58b secured to top and bottom edge of the mounting panel 52, i.e., edges of the mounting panel 52 offset from one another in the vertical direction 12c during use. However, in other embodiments, two extensions 58a, 58b are secured to the left and right edges of the mounting panel 52, i.e., edges of the mounting panel 52 offset from one another in the longitudinal or horizontal direction 12a, 12b during use. The extensions 58a, 58b may be planar members, e.g., having top and bottom surfaces that are substantially (e.g., within 5 degrees of) parallel to the longitudinal and horizontal directions 12a, 12b.

One or both of the extensions 58a, 58b may have mounting flanges 60a, 60b secured thereto. The mounting flanges 60a, 60b may extend outwardly from the extensions 58a, 58b in the vertical direction 12c during use. The mounting flanges 60a, 60b may extend perpendicularly outwardly from the extensions 58a, 58b. For example, the mounting flanges 60a, 60b may have surfaces that are parallel to the horizontal and vertical directions 12b, 12c (when mounted to the back wall 22) or parallel to the longitudinal and vertical directions 12a, 12c (when mounted to a sidewall 18).

In the illustrated embodiment, the mounting flange 60a mounted to the upper extension 58a extends inward, i.e., towards the lower extension 58b, and the mounting flange 60b mounted to the lower extension 58b extends outward, i.e., away from the upper extension 58a.

Each mounting flange 60a, 60b includes structures for mounting to the back wall 20 or sidewall 18. For example, the mounting flanges 60a, 60b may include openings 62 for receiving fasteners 64 passing through the openings 62 and engaging the threaded openings 48. In the illustrated embodiment, the openings 62 in the mounting flange 60a are open ended slots facing downwardly whereas the openings 62 in the mounting flange 60b have closed perimeters. However, the opposite arrangement is also possible. Likewise, the openings 62 of one of the mounting flanges 60a, 60b may have a closed perimeter but be oblong with the long dimension thereof oriented substantially (e.g., within 5 degrees of) parallel to the vertical direction 12c during use. In use, the mounting flanges 60a, 60b may abut the back wall 22 or sidewall 18 to which the accessory mount is secured. The use of openings 62 and fasteners 64 is exemplary only. Other fastening approaches may also be used.

In some embodiment, the mounting panel 52 includes access openings 66 aligned with the openings 62, e.g., aligned in the horizontal and vertical directions 12b, 12c (when mounted to the back wall 20) or in the longitudinal and vertical directions 12a, 12c (when mounted to a sidewall 18). The access openings 66 may facilitate insertion of a tool such as a screwdriver, nut driver, socket wrench, or other tool to rotate the fasteners 64 and thread the fasteners 64 into the threaded openings 48. The access openings 66 may be larger than the openings 62 to provide clearance for the tool.

The mounting panel 52, extensions 58a, 58b, and mounting flanges 60a, 60b may be formed of a single piece of metal bent, stamped, forged, or otherwise shaped into a mounting panel 52 and extensions 58 as described herein. The accessory mounting openings 54, mounting openings 62, and access openings 66 may be formed before or after shaping.

The accessory mount 50 may include accessory mount flanges 70a, 70b offset from the mounting panel 52 in a direction perpendicular to the front face 52 and located on an opposite side of the mounting panel 52 from the outward facing surface 52a. As described in greater detail below, the accessory mount flanges 70a, 70b may cooperate with the accessory mount openings 54 to support an accessory mounted to the accessory mount 50. The accessory mount flanges 70a, 70b may be secured to the extensions 58a, 58b or mounting panel 52 by means of welds, screws, rivets, or other fastening means. In the illustrated embodiment, the accessory mount flange 70a extends outwardly from the extension 58a in the same direction as the mounting flange 60a and the accessory mount flange 70b extends outwardly from the extension 58b in the opposite direction from the mounting flange 60b.

The upper mount flange 70a may include one or more indentation 72a. The indentations 72a may be open ended with the open end facing downwardly along the vertical direction 12c during use. In the illustrated embodiment, the indentations 72a extending inwardly from a distal edge of the upper mount flange 70a. However, in other embodiments, the indentation 72a may be a portion of a closed perimeter of an opening. Each indentation 72a may be aligned with an accessory mount openings 54 along the horizontal direction 12b when mounted to the back wall 22 or along the longitudinal direction 12a when mounted to a side wall 18, such as an opening 54 of the upper group 56.

A top of each indentation 72a and a top of the opening 54 with which each indentation 72a is aligned in the longitudinal or horizontal direction 12a, 12b may be either (a) aligned in the vertical direction 12c or (b) have the top of the indentation 72a positioned slightly (e.g., up to 0.5 mm, up to 1 mm, or up to 2 mm) lower than the top of the opening 54 in the vertical direction 12c during use.

The lower mount flange 70b may include one or more opening 72b. The opening 72b may be open ended as the indentations 72a with the open end facing downwardly along the vertical direction 12c during use. However, in the illustrated embodiment, the opening 72b has a closed perimeter. The opening 72b may be oblong with the long dimension thereof oriented substantially (e.g., within 5 degrees of) parallel to the vertical direction 12c during use. Each indentation 72b may be aligned with an accessory mount opening 54 along the horizontal direction 12b when mounted to the back wall 22 or along the longitudinal direction 12a when mounted to a side wall 18, such as an opening 54 of the lower group 56. In the illustrated embodiment, the opening 72b extends completely to the extension 38b.

A top of each opening 72b and a top of the opening 54 with which each opening 72b is aligned in the longitudinal or horizontal direction 12a, 12b may be either (a) aligned in the vertical direction 12c or (b) have the top of the opening 72b positioned slightly (e.g., up to 0.5 mm, up to 1 mm, or up to 2 mm) lower than the top of the opening 54 during use.

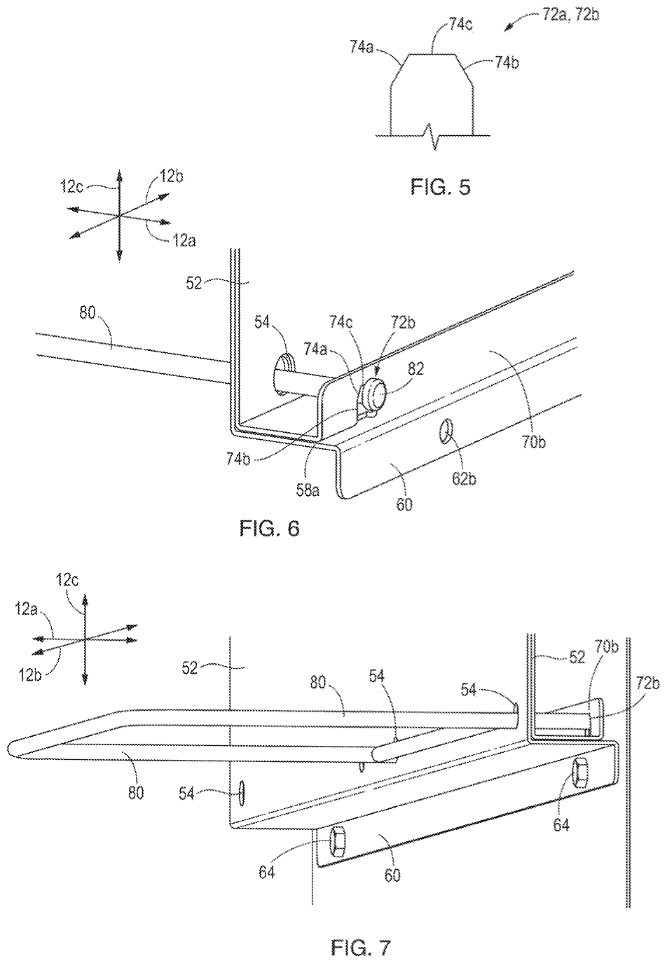

As shown in FIG. 5, the indentation 72a and upper portions of the opening 72b may be non-circular. For example, the indentation 72a and upper portion of the opening 72b may include angled surfaces 74a, 74b. The angled surfaces 74a, 74b may be angled inwardly toward one another, i.e., becoming closer to one another with movement upwardly along the vertical direction 12c. A flat or round surface 74c may be positioned at the top of the angled surfaces 74a, 74b. A widest separation between the angled surfaces 74a, 74b of an indentation 72a or opening 72b may be equal to or greater than a diameter of the accessory mount opening 54 with which each indentation 72a or opening 72b is aligned and the surface 74c may have a width in the longitudinal direction 12a or horizontal direction 12b that is smaller than the opening 54.

Referring to FIGS. 6 and 7, an accessory to be mounted to the accessory mount 50 may include, one, two, or more rods 80 sized to insert within the accessory mount openings 54. In use, each rod 80 is inserted through an accessory mount opening 54 and inserted into an indentation 72a or opening 72b. In the illustrated embodiment, each rod 80 has an end portion 82 that is wider than the rod 80. For example, the rod 80 may be cylindrical, or include a cylindrical portion to which the end portion 82 secures, and define an axis of symmetry with the end portion 82 extending outwardly from the rod 80 perpendicular to the axis of symmetry. The end portion 82 may be round as shown or may be square or have some other shape. The end portion 82 may be sized to insert through the accessory mount openings 54 as well.

In use, the rod 80 may slide between the angled surfaces 74a, 74b with the end portion 82 positioned between the accessory mount flange 70a, 70b and the mounting flange 60a, 60b. The end portion 82 therefore resists removal of the rod 80 in response to forces parallel to the rod 80 (e.g., the longitudinal direction 12a when the accessory mount 50 is mounted to the back wall 22 or the horizontal direction 12b when mounted to a side wall 18). The rod 80 will be pressed against the angled surfaces 74a, 74b by weight applied to the rod 80 extending outwardly from the outward facing surface 52a of the mounting panel 52, which helps center and immobilize the rod 80 within the slot 72a or opening 72b.

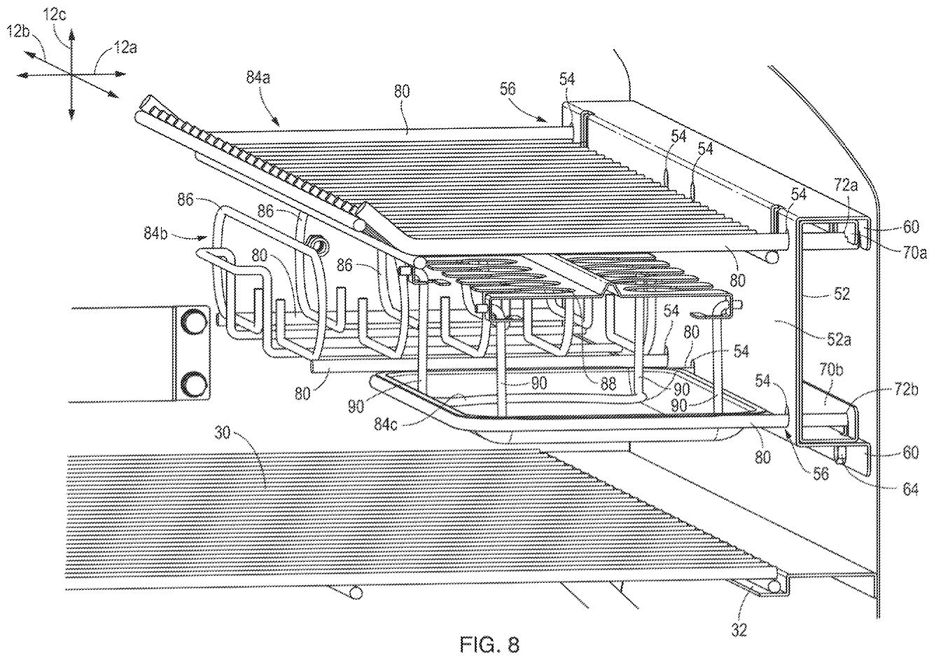

Referring to FIG. 8, many different accessories may have rods 80 affixed thereto and configured to mount to the accessory mount 50. The rods 80 may function solely for mounting to the accessory mount or may be extensions of a frame of the accessory.

For example, a grill 84a may include rods 80 forming sides of the grill 84a, with various other rods 84 extending between the rods 80 to form the grill 84a. The grill 84a may include rods 80 offset from one another such that the rods 80 insert into the outer accessory mount openings 54 of the upper or lower group 56. In another example, a rack 84b includes rods 80 having dividers 86 secured thereto and providing holding positions for items to be cooked. In yet another example, a tray 84c is mounted to rods 80, such as rods 80 formed as a single member bent to form a frame for supporting the tray 80. The tray 80 may have a rack 88 mounted thereto for suspending items from such that the tray 80 collects drippings from an item suspended from the rack 88. The rack 88 may include legs 90 mounted thereto and supporting the rack 88 at an offset distance above the tray 84c. In the illustrated embodiment, the rods 80 of rack 84b and tray 84c extend into an outer opening 54 and a closest inner opening 54 of the upper or lower group 56.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An apparatus comprising:
a mounting panel having a front surface defining accessory mount openings;
a mounting flange offset from the mounting panel in a first direction perpendicular to the front surface, the mounting flange configured to mount the mounting panel to a wall of a cooker; and
an accessory mount flange positioned between the mounting panel and the mounting flange along the first direction and offset from the mounting panel along the first direction, the accessory mount flange defining a plurality of accessory mounting features, each accessory mounting feature of the plurality of accessory mounting features being aligned with one accessory mount opening of the accessory mount openings along a second direction perpendicular to the first direction.

2. The apparatus of claim 1, wherein each accessory mounting feature of the plurality of accessory mounting features is one of an opening and an open-ended indentation.

3. The apparatus of claim 2, wherein:
the accessory mount flange is a first accessory mount flange and the plurality of accessory mounting features are first accessory mounting features, the apparatus further comprising a second accessory mount flange positioned between the mounting flange and the mounting panel along the first direction, the second accessory mount flange defining second accessory mounting features, the first and second accessory mount flanges offset from one another in the second direction; and
the first accessory mounting features are open-ended indentations and the second accessory mounting features are each an opening with a closed perimeter.

4. The apparatus of claim 1, wherein each mounting features includes first and second surfaces angled inwardly toward one another.

5. The apparatus of claim 1, wherein the mounting flange is a first mounting flange, the apparatus further comprising:
a second mounting flange offset from the first mounting flange in the second direction;
a first extension extending between the mounting panel and the first mounting flange; and
a second extension extending between the mounting panel and the second mounting flange.

6. The apparatus of claim 5, the accessory mount flange is a first accessory mount flange and the plurality of accessory mounting features are first accessory mounting features, the apparatus further comprising a second accessory mount flange defining second accessory mounting features, wherein:
the first accessory mount flange is secured to the first extension and extends outwardly from the first extension and toward from the second extension; and
the second accessory mount flange is secured to the second extension and extends outwardly from the second extension and toward the first extension.

7. The apparatus of claim 6, wherein:
the first mounting flange is secured to the first extension and extends outwardly from the first extension and toward from the second extension; and
the second mounting flange is secured to the second extension and extends outwardly from the second extension and away from the first extension.

8. A system comprising:
a cooker including:
a housing defining a cooking chamber;
a heat source; and
a plurality of mounting points accessible within the cooking chamber;
an accessory mount comprising:
a mounting panel defining accessory mount openings;
first and second mounting flanges offset from the mounting panel in a first direction and secured to the plurality of mounting points; and
an accessory mount flange positioned between the mounting panel and the first and second mounting flanges along the first direction, the accessory mount flange defining plurality of accessory mounting features, each accessory mounting feature of the plurality of accessory mounting features being aligned with one accessory mount opening of the accessory mount openings along a second direction perpendicular to the first direction; and
an accessory comprising:
a first rod extending into a first accessory mount opening of the accessory mount openings and engaging a first accessory mounting feature of the plurality of accessory mounting features that is aligned with the first accessory mount opening along the second direction; and
a second rod extending into a second accessory mount opening of the accessory mount openings and engaging a second accessory mounting feature of the plurality of accessory mounting features aligned with the second accessory mount opening along the second direction.

9. The system of claim 8, wherein:
the first rod has a first widened end portion positioned between the first mounting flange and the accessory mount flange along the first direction and the second rod has a second widened end portion positioned between the first mounting flange and the accessory mount flange along the first direction.

10. The system of claim 8, wherein the accessory includes a grill mounted to the first and second rods.

11. The system of claim 8, wherein the accessory comprises a rack including one or more dividers.

12. The system of claim 8, wherein the accessory comprises a tray supported by the first and second rods.

13. The system of claim 12, wherein the accessory comprises a grill supported by the tray.

14. The system of claim 8, further comprising a grill positioned within the housing between the plurality of mounting points and the heat source.

15. The system of claim 8, wherein the heat source is at least one of a burn box and pellet feeder, a chip feeder, a gas burner, and an electric heating element.

16. The system of claim 8, wherein each accessory mounting feature of the plurality of accessory mounting features is one of an opening and an open-ended indentation.

17. The system of claim 8, wherein each mounting feature includes first and second surfaces angled inwardly toward one another, the first rod seated against the first and second surfaces of the first accessory mounting feature and the second rod pressing upwardly against the first and second surfaces of the second accessory mounting feature.

18. The system of claim 8, wherein:
the accessory mount flange is a first accessory mount flange and the plurality of accessory mounting features are first accessory mounting features;
the accessory mount further comprising a second accessory mount flange positioned between the mounting panel and the first and second mounting flanges along the first direction, the second accessory mount flange defining second accessory mounting features; and
the first accessory mounting features are open-ended indentations and the second accessory mounting features are each an opening with a closed perimeter.

19. The system of claim 18, further comprising a first extension extending between the mounting panel and the first mounting flange and a second extension extending between the mounting panel and the second mounting flange.

20. The system of claim 19, wherein:
the first accessory mount flange is secured to the first extension and extends outwardly from the first extension and toward from the second extension; and
the second accessory mount flange is secured to the second extension and extends outwardly from the second extension and toward the first extension.
